(19) United States
(12) Patent Application Publication
(10) Pub. No.: US 2026/0195480 A1
(43) Pub. Date: Jul. 9, 2026

(54) METHOD, DEVICE, AND PROGRAM PRODUCT FOR DETECTING DATA ANOMALY

(71) Applicant: DELL PRODUCTS L.P., ROUND ROCK, TX (US)

(72) Inventors: Huifeng LI, Shanghai (CN); Yongbing XUE, Shanghai (CN); Weiyang LIU, Shanghai (CN); Yuanyi LIU, Shanghai (CN); Mengze LIAO, Shanghai (CN)

(21) Appl. No.: 19/057,587

(22) Filed: Feb. 19, 2025

(30) Foreign Application Priority Data
Jan. 8, 2025 (CN) 202510028572.9

(51) Int. Cl. G06F 21/62; G06F 21/64

(52) U.S. Cl. CPC G06F 21/6245; G06F 21/64

(57) ABSTRACT

The present disclosure relates to a method, a device, and a computer program product for detecting a data anomaly. The method includes acquiring a first feature of user data, where the user data includes at least one of a protection job property and an agent property. The method further includes generating a second feature by an auto-encoder based on the first feature, where the first feature and the second feature have the same dimensions, and the auto-encoder includes an encoder and a decoder. In addition, the method further includes detecting, based on the first feature and the second feature, a data anomaly in the user data.

### TECHNICAL FIELD

The present disclosure generally relates to the field of computers, and more specifically, to a method, an electronic device, and a program product for detecting a data anomaly.

### BACKGROUND

Data protection is critical in today's digital age. With the wide application of digital technologies, data has become an indispensable core asset. Once the data security is compromised, it not only leads to the leakage of sensitive information and causes legal risk and trust crisis, but also may cause significant losses.

Data anomalies are an important aspect that threatens data security. There are a variety of reasons for data anomalies, including but not limited to network attacks and natural disasters. Data extortion is particularly adverse. Data extortion refers to a malicious behavior that an attacker encrypts user data or limits data access, then demands a victim to pay ransom to restore data access or avoid data leakage, which poses a serious threat to data security.

### SUMMARY OF THE INVENTION

A method, a device, and a computer program product for detecting a data anomaly are proposed in embodiments of the present disclosure.

In a first aspect according to the embodiments of the present disclosure, a method for detecting a data anomaly is provided. The method includes acquiring a first feature of user data, where the user data includes at least one of a protection job property and an agent property. The method further includes generating a second feature by an auto-encoder based on the first feature, where the first feature and the second feature have the same dimensions, and the auto-encoder includes an encoder and a decoder. In addition, the method further includes detecting, based on the first feature and the second feature, a data anomaly in the user data.

In a second aspect according to the embodiments of the present disclosure, an electronic device is provided. The electronic device includes one or a plurality of processors; and a storage apparatus for storing one or a plurality of programs, wherein the one or plurality of programs, when executed by the one or plurality of processors, cause the one or plurality of processors to implement a method for detecting a data anomaly. The method includes acquiring a first feature of user data, where the user data includes at least one of a protection job property and an agent property. The method further includes generating a second feature by an auto-encoder based on the first feature, where the first feature and the second feature have the same dimensions, and the auto-encoder includes an encoder and a decoder. In addition, the method further includes detecting, based on the first feature and the second feature, a data anomaly in the user data.

In a third aspect according to the embodiments of the present disclosure, a computer-readable storage medium is provided, on which a computer program is stored, wherein the program, when executed by a processor, implements a method for detecting a data anomaly. The method includes acquiring a first feature of user data, where the user data includes at least one of a protection job property and an agent property. The method further includes generating a second feature by an auto-encoder based on the first feature, where the first feature and the second feature have the same dimensions, and the auto-encoder includes an encoder and a decoder. In addition, the method further includes detecting, based on the first feature and the second feature, a data anomaly in the user data.

It should be understood that the content described in the Summary of the Invention section is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 is a schematic diagram of an example environment in which a plurality of embodiments of the present disclosure can be implemented;

FIG. 2 is a flow chart of a method for detecting a data anomaly according to some embodiments of the present disclosure;

FIG. 3 is a schematic diagram of an auto-encoder according to some embodiments of the present disclosure;

FIG. 4A to FIG. 4F are diagrams of training an auto-encoder and applying the auto-encoder according to some embodiments of the present disclosure;

FIG. 5A to FIG. 5C are diagrams of training and inference application effects of an auto-encoder according to some embodiments of the present disclosure; and

FIG. 6 is a block diagram of a device that can be configured to implement a plurality of embodiments of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

As mentioned above, data has become an indispensable core asset, and data anomalies are an important aspect that threatens data security. Conventional data anomaly detection models, especially statistical models, face multiple challenges in dealing with data anomaly detection. These challenges mainly derive from factors such as significant differences in index data generated by back-up tasks of different data assets and frequent changes in the data assets themselves, so that it is difficult to implement the task of data state detection. At the same time, although there are some methods that rely on the experience of engineers to detect whether the data is abnormal, they are effective to a certain extent, but these methods often need to consume a lot of resources and require the highest system authority, which increases the difficulty and cost of data state detection.

Therefore, a solution for detecting a data anomaly is proposed in the embodiments of the present disclosure. In the embodiments of the present disclosure, whether user data is abnormal is analyzed by means of an auto-encoder. First, a first feature determined based on user data is acquired, where the user data includes at least one of a protection job property and an agent property. Then, a second feature having the same dimensions as the first feature is generated based on the first feature by an auto-encoder having an encoder and a decoder, and then whether the user data is abnormal is determined based on the first feature and the second feature.

By selecting the auto-encoder as an anomaly analysis model, whether the state of the data is abnormal can be effectively detected while avoiding the influence of factors such as data changes (for example, significant differences in index data generated by back-up tasks of different data assets and frequent changes in the data assets themselves), thereby improving the user experience.

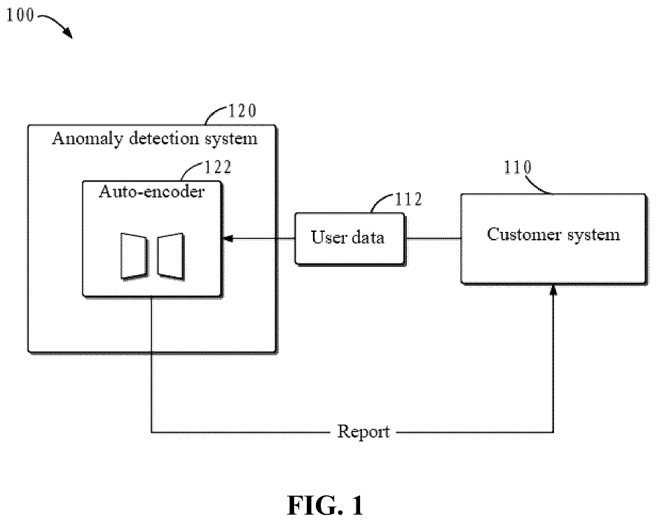

FIG. 1 is a schematic diagram of an example environment 100 in which a plurality of embodiments of the present disclosure can be implemented. As shown in FIG. 1, in order to ensure data security of a customer system 110, whether data of the customer system 110 is abnormal may be detected by a data anomaly detection system 120. The customer system 110 may send user data 112 acquired in a protection mode to the anomaly detection system 120 in order to detect whether the data asset that needs to be protected by a user is abnormal by an auto-encoder having a data anomaly detection function in the anomaly detection system 120.

Referring to FIG. 1, the user data 112 may include at least one of a protection job property and an agent property. The protection job properties refer to, in tasks related to protection operations such as back-up and recovery, various parameters and settings for describing and configuring these tasks. These properties define key information of the tasks such as behavior, schedule, source, and destination, so as to ensure data security and recoverability. The agent properties are configurations and settings associated with agents in the customer system 110. The agents are software components installed on protected systems or devices, and are responsible for performing various tasks, such as data back-up, monitoring, recovery, and configuration management. The agent properties define behaviors and functions of the agents, and interaction manners thereof with a central management system or other components. To some extent, such user data 112 requires no data content itself stored in the customer system, but only some objective descriptive data.

In some embodiments, in order to determine whether the user data 112 of the customer system 110 is abnormal, a first feature associated with the user data 112 may be extracted from the user data 112, and then the first feature may be input into an auto-encoder 122 to obtain a second feature reconstructed by the auto-encoder 122.

In some embodiments, the auto-encoder 122 may include an encoder and a decoder, where the encoder is responsible for mapping high-dimensional input data to a low-dimensional latent space to generate a compressed representation. This compressed representation is often referred to as “coding” or “latent vector.” The decoder remaps the compressed representation generated by the encoder back to an original input space to generate a reconstructed output. Ideally, the reconstructed output should be as close to an original input as possible.

At this time, it may be determined whether the user data 112 of the customer system 110 is abnormal based on the first feature and the second feature. In some embodiments, it may be determined whether the user data 112 is abnormal by comparing difference values of the first feature and the second feature. In some embodiments, to further enhance the accuracy of the data state detection, it may be determined whether the data of the customer system 110 is abnormal by determining whether the difference values of the first feature and the second feature follow a confidence interval distribution.

In some embodiments, if the anomaly detection system 120 detects that there is an anomaly in the user data of the customer system 110, a report may be sent to the customer system 110 to notify the customer system 110 so that the customer system 110 can notify a data protection engineer or administrator to manually adjust the protection strategy or modify the data protection strategy to save the latest version of data of the user, thereby achieving the purpose of avoiding an anomaly attack.

The method for detecting whether the user data is abnormal by using the auto-encoder not only can improve the accuracy of data anomaly determination, but also can avoid the influence of data change and other factors (for example, significant differences in index data generated by back-up tasks of different data assets and frequent changes in the data assets themselves) on the data anomaly detection, thereby reducing the cost of data detection, and improving the user experience.

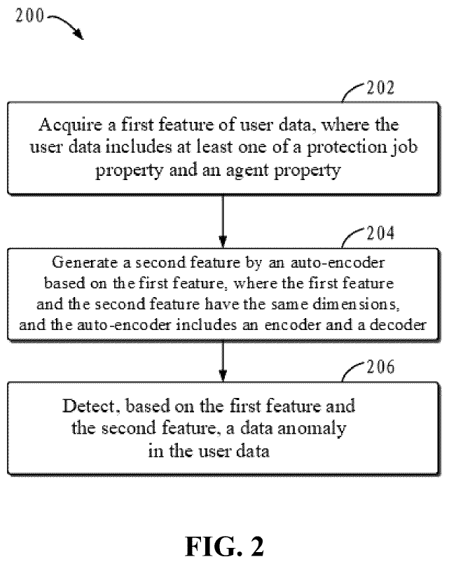

FIG. 2 is a flow chart of a method 200 for detecting a data anomaly according to some embodiments of the present disclosure. Subsequently, the method 200 is schematically illustrated with the anomaly detection system 120 shown in FIG. 1 being an execution subject as an example. The method 200 includes a block 202, a block 204, and a block 206.

At the block 202, a first feature of user data is acquired, where the user data includes at least one of a protection job property and an agent property. Referring to FIG. 1, in some embodiments, in order to determine whether the user data 112 of the customer system 110 is abnormal, a first feature associated with the user data 112 may be extracted from the user data 112. The user data 112 may include at least one of a protection job property and an agent property. The protection job properties refer to, in tasks related to protection operations such as back-up and recovery, various parameters and settings for describing and configuring these tasks. The agent properties may be configurations and settings associated with agents in the customer system 110.

At the block 204, a second feature is generated by an auto-encoder based on the first feature, where the first feature and the second feature have the same dimensions, and the auto-encoder includes an encoder and a decoder. Referring to FIG. 1, in some embodiments, in order to determine whether the user data 112 of the customer system 110 is abnormal, the first feature associated with the user data 112 may be extracted from the user data 112, and then input into the auto-encoder 122 to obtain a second feature reconstructed by the auto-encoder 122. At this point, the first feature and the second feature have the same dimensions. In some embodiments, the auto-encoder 122 may include an encoder and a decoder, where the encoder is responsible for mapping high-dimensional input data to a low-dimensional latent space to generate a compressed representation. The decoder may remap the compressed representation generated by the encoder back to an original input space to generate a reconstructed output.

At the block 206, a data anomaly in the user data is detected based on the first feature and the second feature. Referring to FIG. 1, after the second feature is obtained, it may be determined whether the user data 112 of the customer system 110 is abnormal based on the first feature and the second feature. In some embodiments, it may be determined whether the user data 112 is abnormal by comparing difference values of the first feature and the second feature. In some embodiments, to further enhance the accuracy of the data state detection, it may be determined whether the data of the customer system 110 is abnormal by determining whether the difference values of the first feature and the second feature follow a confidence interval distribution.

The method for detecting whether the user data is abnormal by using the auto-encoder not only can improve the accuracy of data anomaly determination, but also can avoid the influence of data change and other factors (for example, significant differences in index data generated by back-up tasks of different data assets and frequent changes in the data assets themselves) on the data anomaly detection, thereby reducing the cost of data detection, and improving the user experience.

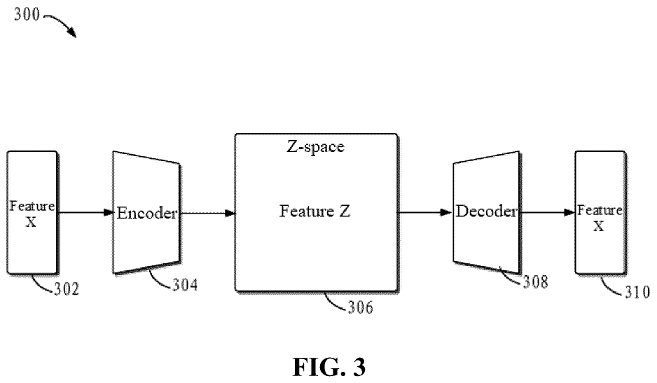

The structure of the auto-encoder will be described below. FIG. 3 is a schematic diagram of an auto-encoder 300 according to some embodiments of the present disclosure. As shown in FIG. 3, the auto-codec 122 includes at least an encoder 304 and a decoder 308, both of which are neural network models. When an input feature X 302 extracted based on the user data is obtained, the high-dimensional feature X 302 may be mapped to a low-dimensional Z space 306 (which may also be referred to as latent space) by the encoder 304 to obtain a feature Z. It is understandable that the dimensions of the feature Z should be smaller than the dimensions of the feature X 302. Thereafter, the feature Z may then be input to the decoder 308 to remap the feature Z back into an original input space to obtain a reconstructed output feature X 310.

In some embodiments, there may also be some linear layers (that is, full connection layers) in the portion between the encoder 304 and the decoder 308, for further compression or expansion of the data and assisting the encoder and decoder in learning more complex representations.

The method using the auto-encoder structure can automatically identify whether input data has abnormal data points based on the comparison of differences between the input data and the output data. The data that cannot be reconstructed is an abnormal data point. Therefore, with the help of the auto-encoder, whether the data is abnormal can be effectively determined based on the difference values between the input data and the output data, so that whether the data state is abnormal can be accurately predicted without considering the risk factors caused by data change, thereby improving the user experience. At the same time, this method does not need to explore the essence of user data, which protects the privacy of the customer system.

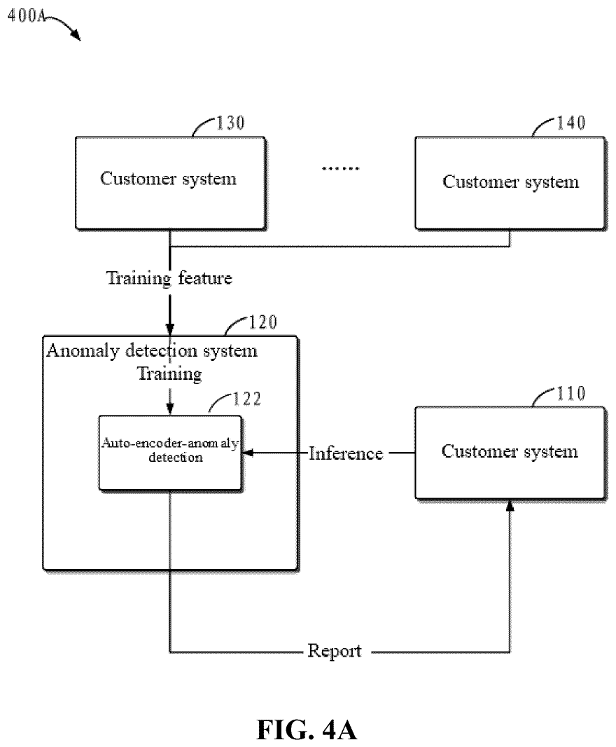

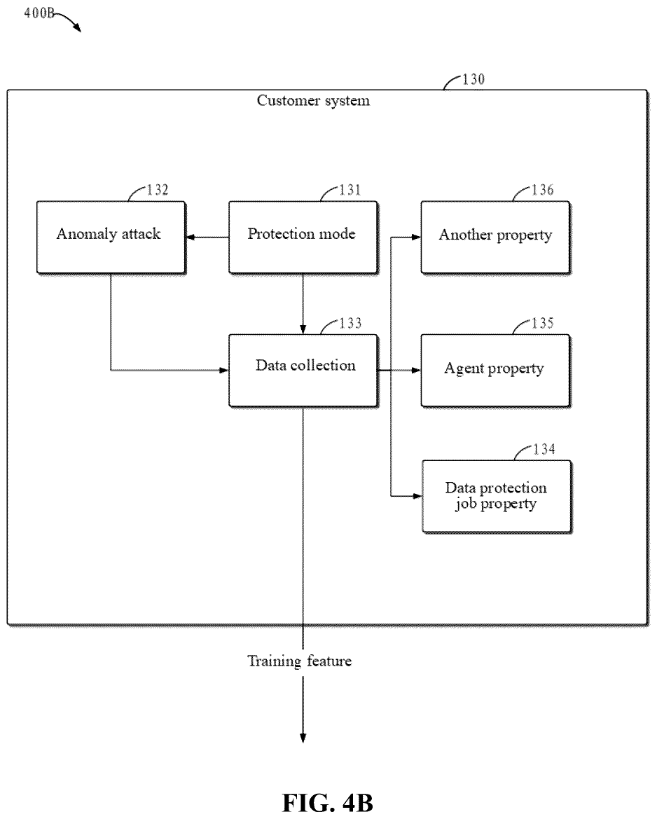

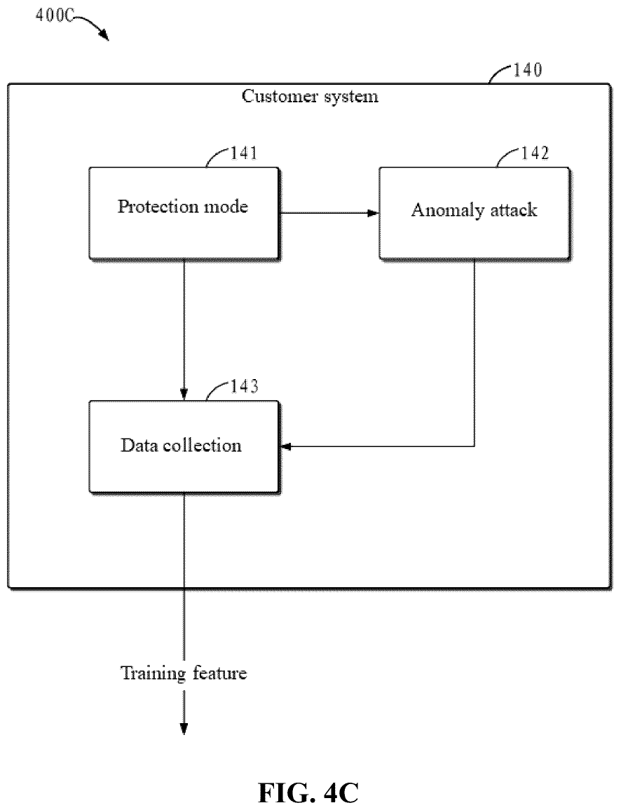

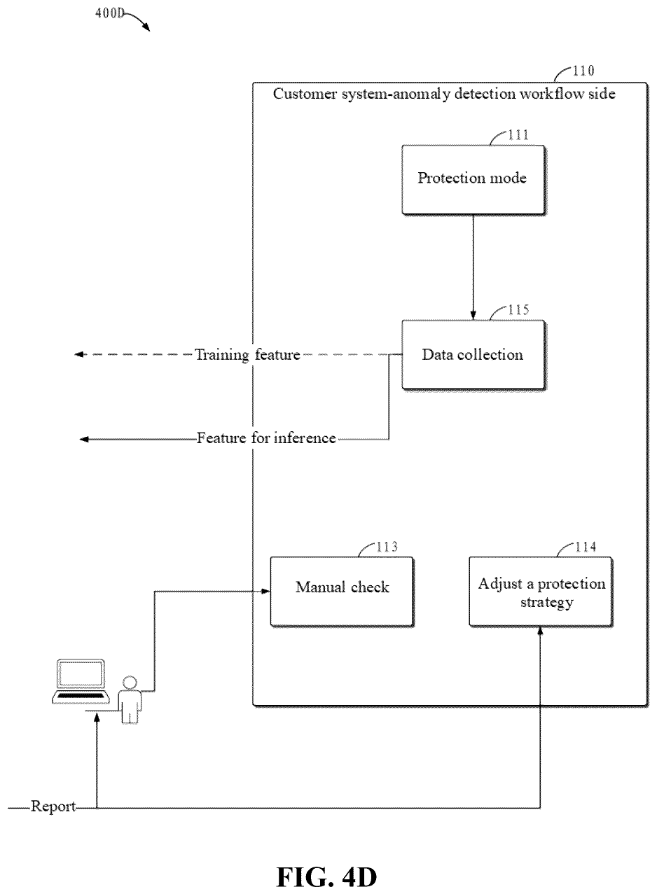

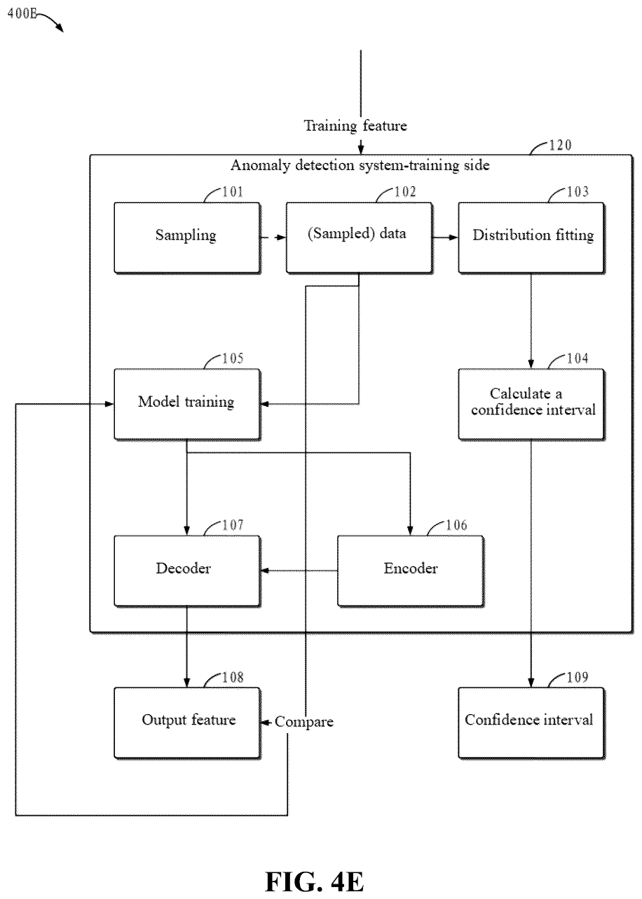

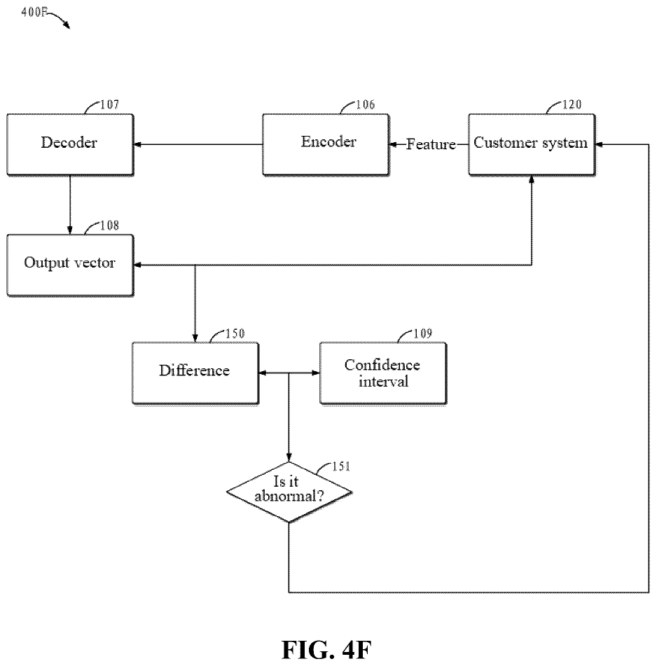

It is understandable that the purpose of training such auto-encoder is to minimize the difference between input data and output data. The training and inference processes of the auto-encoder 112 in the anomaly detection system 110 will be described below with reference to FIG. 4A. FIG. 4A is a schematic diagram of training and applying an auto-encoder 400A according to some embodiments of the present disclosure.

As shown in FIG. 4A, the customer system 110 is an inference-side system, and a customer system 130 and a customer system 140 are training-side systems. That is, data from systems such as the customer system 130 and the customer system 140 may be acquired to train the auto-encoder 122 in the anomaly detection system 120. Once the training data for the auto-encoder 122 has reached a convergence target, it can be used to apply inference to detect whether the data of the customer system 110 is abnormal (for example, whether it has been extorted). When the data of the customer system 110 is identified as abnormal, the anomaly condition may be reported to the customer system 110. It is understandable that the customer system 110 should be a system that has never been subject to an anomaly attack, such that the accuracy of anomaly detection can be ensured.

The process of acquiring training data will be described below with reference to FIG. 4B. FIG. 4B is a schematic diagram of acquiring a training feature 400B from the customer system 130 according to some embodiments of the present disclosure. In order to obtain specific training features used to detect data anomalies, anomaly attacks on the user data may be simulated in a protection mode of the customer system.

As shown in FIG. 4B, when the customer system 130 is in a protection mode 131, an anomaly attack 132 may be launched, and when the customer system 130 responds, an operation of data collection 133 may be performed, that is, relevant data of the customer system 130 may be collected.

Referring to FIG. 4B, in some embodiments, the data that can be collected includes at least one of a data protection job property 134, an agent property 135, or another property 136. The protection job properties refer to, in tasks related to protection operations such as back-up and recovery, various parameters and settings for describing and configuring these tasks. These properties define key information of the tasks such as behavior, schedule, source, and destination, so as to ensure data security and recoverability. The agent properties are configurations and settings associated with agents in the customer system 130. The agents are software components installed on protected systems or devices, and are responsible for performing various tasks, such as data back-up, monitoring, recovery, and configuration management. The agent properties define behaviors and functions of the agents, and interaction manners thereof with a central management system or other components.

In some embodiment, the data protection job property may be at least one parameter of asset size, transmitted bytes, cumulative size, pre-compression ratio, repeated pre-compression ratio, compressed size, number of segments, and redundant segment count of the user data. In some embodiments, the agent property includes at least one parameter of used bytes, changed bytes, moved bytes, final moved bytes, number of read seconds, number of write seconds, and total consumed time of the user data. In this way, after the relevant data is collected by the data collection 133, a training feature for training can be extracted from the data.

Similarly, training data may also be collected in the same manner for another customer system, such as the customer system 140. FIG. 4C is a schematic diagram of acquiring a training feature 400C from the customer system 140 according to some embodiments of the present disclosure. As shown in FIG. 4C, when the customer system 140 is in a protection mode 141, an anomaly attack 142 may be launched, and when the customer system 140 responds, an operation of data collection 143 may be performed, that is, relevant data of the customer system 140 may be collected.

As described above, the customer system 130 and the customer system 140 are training-side systems for collecting training data for training the auto-encoder 122. The customer system 110 on the inference side will be described below. FIG. 4D is a schematic diagram of a structure 400D of the customer system 110 that performs application inference for the auto-encoder 122 according to some embodiments of the present disclosure. It is understandable that the customer system 110 should be a system that has never been subject to an anomaly attack, such that the accuracy of anomaly detection can be ensured.

As shown in FIG. 4D, a feature for inference may be extracted from data collected by data collection 115 performed by the customer system 110 in a protection mode 111, that is, it is input to the auto-encoder 122 for inference to predict whether the relevant data of the customer system 110 is in an abnormal state. If the data is in an abnormal state, the anomaly information may be reported to the customer system 110, and finally the customer system 110 may manually check 113 and adjust the protection strategy for the anomaly report by a data engineer, or the report may be directly sent to the customer system 110 to implement automatic adjustment of a protection strategy 114, thereby being capable of retaining an old version of data of the customer system and thus being capable of protecting the data assets of the customer system.

Meanwhile, it is also understood that training data may also be acquired from the customer system 110 to extract an update training feature for update training of the auto-encoder 122 and simultaneously detecting whether the data state is abnormal. Through the personalized auto-encoder model which can be applied after only pre-training, it is possible to instantly detect whether data is abnormal for users without additional label training, thereby reducing the cost of data anomaly detection.

Back to FIG. 4A, that is, the training data for training the auto-encoder 122 may be obtained from the customer system 130 and several customer systems 140 similar to the customer system 130, and may also be obtained from the customer system 110 on the inference side. In some embodiments, the auto-encoder 122 is trained by using data from customer systems such as the customer system 130 and the customer systems 140 in an initial phase, and then in a later inference application process, the model may be further updated simultaneously based on the data from the customer system 110, and anomalies may be detected simultaneously. Once an anomaly is detected, an administrator or a data engineer of the customer system will be notified to adjust the data protection strategy.

The training process for the auto-encoder 122 will be described below with reference to FIG. 4E. FIG. 4E is a schematic diagram of 400E for training the auto-encoder 122 according to some embodiments of the present disclosure. As shown in FIG. 4E, after the anomaly detection system 120 acquires the training feature, if the amount of data of the acquired training feature is sufficient, the training feature may be sampled at 101 (for example, sampled based on a time series) to obtain sampled data 102, thereby being capable of reducing the computational burden.

In some embodiments, after the data is obtained (after the data is sampled), distribution fitting 103 is also naturally required for the sampled data. If the amount of data of the acquired training feature is insufficient, it is unnecessary to sample the obtained training feature, and all available data may be used directly. It is understandable that, in any case, these steps of performing distribution fitting 103 and calculating the confidence interval 104 of the data are necessary.

In some embodiments, if the quantity of samples is greater than or equal to 30, an analysis method of normal distribution can be applied to the data, and a calculation formula of a corresponding confidence interval is as follows:

$$Confidence interval = ( \overline{X} - {Z}_{\frac{α}{2}} \frac{σ}{\sqrt{n}} , \overline{X} + {Z}_{\frac{α}{2}} \frac{σ}{\sqrt{n}} ) \qquad ( 1 )$$

where x̅ is the sample mean, s is the sample standard deviation, n is the quantity of samples, and

$${Z}_{\frac{α}{2}}$$

is the critical value of the standard normal distribution, for a given significance level α. For a 95% confidence level (α=0.05),

$${Z}_{\frac{α}{2}} = 1.96 .$$

In some embodiments, if the quantity of samples is less than 30, a statistical analysis method of t distribution may be used, and a calculation formula of a corresponding confidence interval is as follows:

$$Confidence interval = ( \overline{X} - {t}_{\frac{α}{2}} ( n - 1 ) \frac{S}{\sqrt{n}} , \overline{X} + {t}_{\frac{α}{2}} ( n - 1 ) \frac{S}{\sqrt{n}} ) \qquad ( 2 )$$

where x̅ is the sample mean, s is the sample standard deviation, n is the quantity of samples, and

$${t}_{\frac{α ( n - 1 )}{2}}$$

is the critical value of the t distribution, for a given significance level α and a degree of freedom n−1. The degree of freedom refers to subtracting 1 from the quantity of samples, and for the 95% confidence level (α=0.05), the corresponding critical value may be searched for through a t distribution table.

Formulas for calculating the mean and the standard deviation in the calculation formula for determining the confidence interval may be as follows:

$$Sample mean \overline{x} = \frac{1}{n} {\sum }_{i = 1}^{n} {x}_{i} \qquad ( 3 )$$

where n is the quantity of samples, and xᵢ is the sample data.

$$Sample standard deviation s = \sqrt{\frac{1}{n - 1} {\sum }_{i = 1}^{n} {( {x}_{i} - \overline{x} )}^{2}} \qquad ( 4 )$$

where n is the quantity of samples, xᵢ is the sample data, and x̅ is the sample mean.

Therefore, after the calculation of the confidence interval 104 is performed, the confidence interval 109 may be obtained for subsequent detection of whether the data is abnormal.

With further reference to FIG. 4E, after the data 102 is obtained, model training 105 may be performed to obtain a converged auto-encoder 122. As previously described for FIG. 3, the auto-encoder includes an encoder and a decoder. That is, the model training 105 is performed for an encoder 106 and a decoder 107. In some embodiments, training data may be input to the encoder 106 to obtain a low-dimensional intermediate compressed representation, and then the intermediate compressed representation may be input to the decoder 107 to obtain an output feature 108. Therefore, the parameters of the model may be adjusted based on a difference between the output feature 108 and the sampled data 102 for training, that is, the model may be adjusted based on the loss between the input feature and the output renewed feature. In some embodiments, a mean absolute error (MAE) method may be adopted to calculate a difference mae between the input feature and the output feature, and the formula is as follows:

$$mae = \frac{1}{m} {\sum }_{i = 1}^{m} \vert {y}_{i} - {\hat{y}}_{i} \vert \qquad ( 5 )$$

where yᵢ is the ith element of the input feature, ŷ_{ι} is the ith element of the output feature of the decoder, and n is the feature dimension.

In some embodiments, the loss function may be a mean squared error or a cross-entropy loss, and by minimizing a reconstruction error, the auto-encoder 122 can learn an effective compressed identifier of the input feature while being capable of retaining important features of each piece of input data.

FIG. 4F is a schematic diagram of 400F for performing an inference application for the auto-encoder 122 according to some embodiments of the present disclosure. As shown in FIG. 4F, the input feature may be captured by the customer system (client) 110, and then the anomaly detection system 120 may input it to the encoder 106 to obtain a compressed intermediate representation. Thereafter, the decoder 107 is able to reconstruct the output feature 108 from the compressed intermediate representation, then obtain a difference 150 between the output 108 and the input feature by an absolute error averaging method, and then verify the difference 150 and compare it with the confidence interval 109 to determine whether an anomaly exists at 151. If an anomaly exists, a report is sent to the customer system (client) 110 to retain the latest version of normal data for the customer system.

The method for detecting whether the user data is abnormal by using the auto-encoder not only can improve the accuracy of data anomaly determination, but also can avoid the influence of data change and other factors (for example, significant differences in index data generated by back-up tasks of different data assets and frequent changes in the data assets themselves) on the data anomaly detection, thereby reducing the cost of data detection, and improving the user experience.

The experimental effects of processing compressed and deduplicated data by using the auto-encoder 122 during training (the size of a training set is 1702, and the size of a validation set is 380) will be described below, where the structure of the auto-encoder may be shown in Table 1 below:

TABLE 1

| | Encoder | | | | Decoder | | | |
|---|---|---|---|---|---|---|---|---|
| Layer | 1st | 2nd | 3rd | 4th | 1st | 2nd | 3rd | 4th |
| sequence | layer | layer | layer | layer | layer | layer | layer | layer |
| Quantity of | 6 | 12 | 12 | 4 | 4 | 12 | 12 | 6 |
| neurons | | | | | | | | |

In some embodiments, when the auto-encoder 122 is trained, parameters in the agent property or data protection job property acquired from the customer system may be a data size before compression, a data size after compression, a data size before compression after deduplication, transmission bytes, the quantity of data segments, and the quantity of redundant data segments, in total of 6 parameter features, with 6 neurons corresponding to an input layer of the encoder. Therefore, the encoder can compress the 6-dimensional input data into one 4-dimensional intermediate representation, which can reduce the data dimensions while extracting key features. Similarly, the structure of the decoder may also have 4 layers, an input layer of the decoder receives a 4-dimensional intermediate identifier from the encoder, and decodes it back to the 6-dimensional output feature to obtain a reconstructed feature.

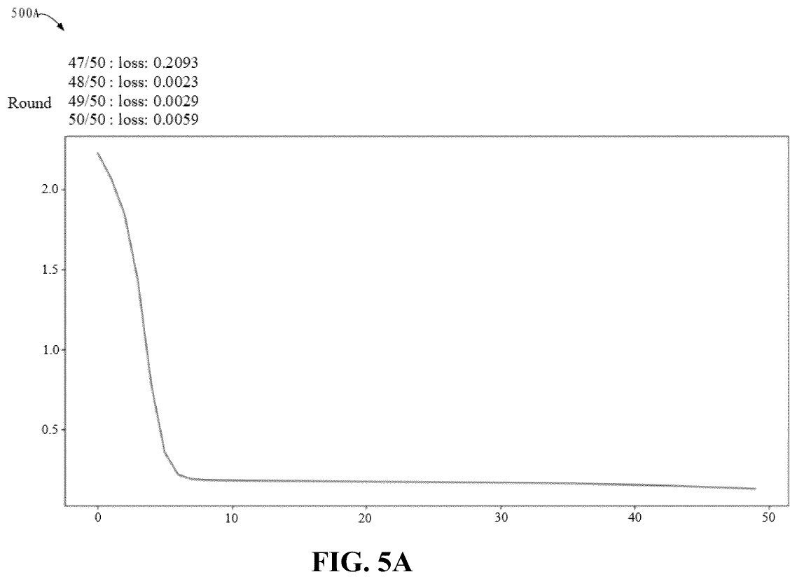

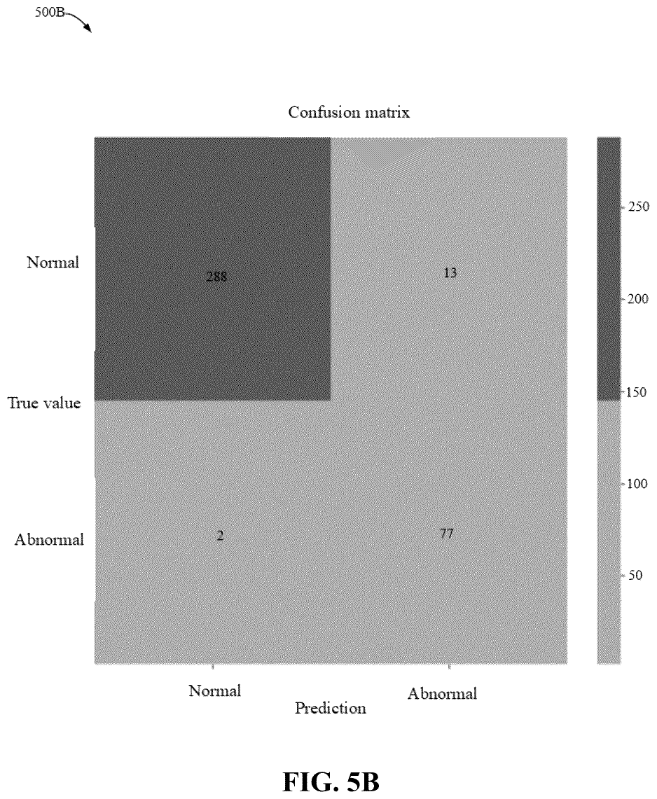

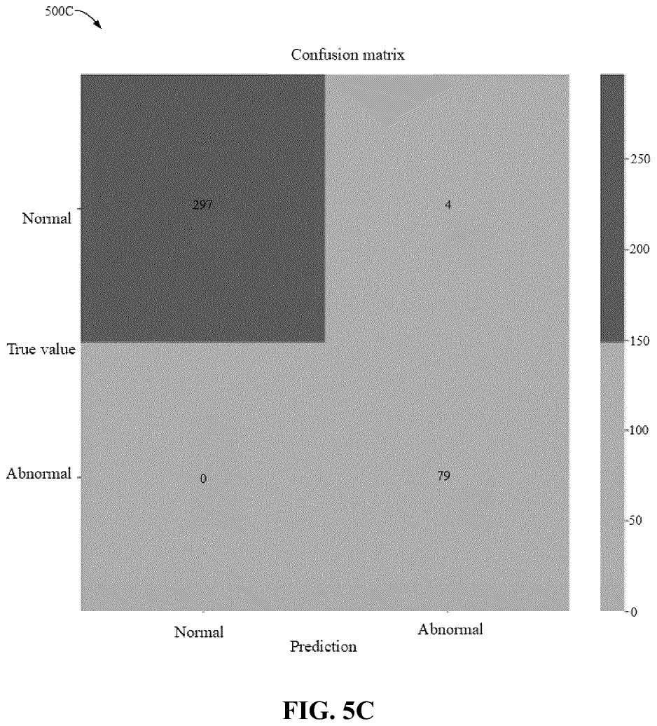

In some embodiments, the number of training rounds (Epochs) may be 50 during training, and by the 50 epochs of training, the auto-encoder can gradually optimize its parameters to minimize reconstruction errors. In some embodiments, the auto-encoder uses the mean squared error (MSE) or the mean absolute error (MAE) as a loss function to measure the difference between the input data and the decoder output. Referring to FIG. 5A, FIG. 5A is a schematic diagram of a loss 500A after training an auto-encoder for 50 cycles according to some embodiments of the present disclosure. As shown in FIG. 5A, after 50 epochs of training, a loss of approximately 0.003 is obtained by calculation using the mean absolute error (MAE) method. If the calculated difference exceeds the confidence interval, it may be considered an abnormal state.

FIG. 5B is a schematic diagram of a confusion matrix 500B after training an auto-encoder for 50 cycles according to some embodiments of the present disclosure. As shown in FIG. 5B, as can be known from the confusion matrix, the accuracy and recall rate of the model are 0.993 and 0.957, respectively.

In some embodiments, in order to further improve the accuracy of auto-encoder training, attempts may be made to train the auto-encoder by using a variety of activation functions. For example, activation functions including Sigmoid, Tanh, ReLU, PReLU, ELU, and the like may be used. The experimental results are not very different when different activation functions are used. Therefore, considering the efficiency of the model training, ReLU and PReLU may be selected as the activation functions. This is because ReLU is simple in calculation and fast in training, and PReLU can alleviate the “dead neurons” problem of ReLU to a certain extent, which is suitable for more complex tasks.

In some embodiments, the dimensions of the input features of the auto-encoder are not very large, and therefore, 2 to 3 linear layers may be set in the middle in addition to the input layer and the output layer, which can avoid over-fitting of the model (that is, the training loss is less than 0.001).

In some embodiments, the quantity of neurons may be set to 12 to 32 in view of the phenomenon of overfitting caused by an excessive quantity of neurons. In some embodiments, depending on the experimental results, if the quantity of neurons is large, some Dropout layers may be added to prevent over-fitting of the auto-encoder model. The Dropout is a regularization technique. It may discard a part of neurons at random in the training process to prevent the model from depending on specific neurons, thereby improving the generalization ability of the model. In some embodiments, the Dropout layer may be added when there are 3 layers of network layers and the quantity of neurons per layer exceeds 30.

In some embodiments, according to experimental results, after attempting a plurality of values with a learning rate between 0.00005 and 0.01, when the learning rate is set to 0.0002 to 0.001, the learning effect of the auto-encoder is good, that is, the learning rate in this range can achieve a good balance between the training efficiency and the model performance.

In some embodiment, based on the experiment results, the performance of the auto-encoder model is not significantly improved after 50 epochs of training the model, and the number of epochs of model training may thus be set to a large value (for example, 200 to 500) and an early stop value may be set to a small value (for example, 20 to 50), which can ensure that the auto-encoder can have enough time to converge and can also avoid over-fitting.

FIG. 5C is a schematic diagram of a confusion matrix 500C of an auto-encoder after adjustment of experimental training results according to some embodiments of the present disclosure. The ReLU activation function is sampled in the structure of the adjusted auto-encoder. There are 3 linear layers, and each linear layer has 16 neurons. According to the adjustment of the above experimental results (the training epochs are 200, and the early stop value is 20), the confusion matrix of the new auto-encoder is shown in FIG. 5C, the accuracy rate of the auto-encoder is 99%, and the recall rate is 100%.

The method for detecting whether the user data is abnormal by using the auto-encoder not only can improve the accuracy of data anomaly determination, but also can avoid the influence of data change and other factors (for example, significant differences in index data generated by back-up tasks of different data assets and frequent changes in the data assets themselves) on the data anomaly detection, thereby reducing the cost of data detection, and improving the user experience.

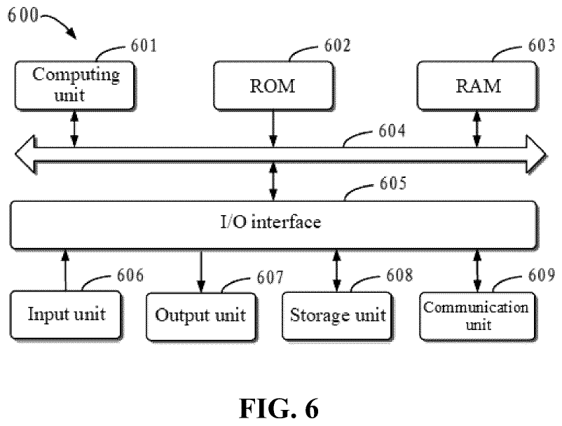

FIG. 6 is a schematic block diagram of an example device 600 that can be used to implement embodiments of the present disclosure. As shown in the figure, the device 600 includes a computing unit 601 that can perform various appropriate actions and processing according to computer program instructions stored in a read-only memory (ROM) 602 or computer program instructions loaded from a storage unit 608 to a random access memory (RAM) 603. Various programs and data required for the operation of the storage device 600 may also be stored in the RAM 603. The computing unit 601, the ROM 602, and the RAM 603 are connected to each other through a bus 604. An input/output (I/O) interface 605 is also connected to the bus 604.

Multiple components in device 600 are connected to I/O interface 605, including: input unit 606, such as a keyboard or a mouse; output unit 607, such as various types of displays or speakers; storage unit 608, such as a magnetic disk or an optical disc; and communication unit 609, such as a network card, a modem, or a wireless communication transceiver. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processing described above, such as the method 200. For example, in some embodiments, the method 200 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the computing unit 601, one or more steps of the method 200 described above can be performed. Alternatively, in other embodiments, the computing unit 601 can be configured to perform the method 200 in any other suitable manners (e.g., by means of a firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general-purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for detecting a data anomaly, comprising:
acquiring a first feature of user data, wherein the user data comprises at least one of a protection job property and an agent property;
generating a second feature by an auto-encoder based on the first feature, wherein the first feature and the second feature have the same dimensions, and the auto-encoder comprises an encoder and a decoder; and
detecting, based on the first feature and the second feature, a data anomaly in the user data.

2. The method according to claim 1, wherein generating the second feature by the auto-encoder based on the first feature comprises:
generating a third feature by the encoder based on the first feature, wherein the dimensions of the third feature are less than the dimensions of the first feature; and
generating the second feature by the decoder based on the third feature.

3. The method according to claim 2, wherein detecting, based on the first feature and the second feature, the data anomaly in the user data comprises:
determining a difference value between the first feature and the second feature; and
determining whether the difference value is in a confidence interval, wherein the confidence interval is determined based on the user data.

4. The method according to claim 3, wherein determining whether the difference value is in the confidence interval comprises:
determining, in response to the difference value being in the confidence interval, that the user data is normal; and
determining, in response to the difference value being outside the confidence interval, that the user data is abnormal.

5. The method according to claim 1, further comprising:
training the encoder and the decoder based on a training feature, wherein the training feature is determined based on training user data.

6. The method according to claim 5, wherein training the encoder and the decoder based on the training feature comprises:
acquiring the training user data in response to detecting an attack on a training user data system, wherein the training user data comprises at least one of a training protection job property and a training agent property; and
extracting the training feature based on the training user data.

7. The method according to claim 6, further comprising:
generating a second training feature by a training encoder and a training decoder based on a first training feature; and
adjusting, based on a loss between the first training feature and the second training feature, the training encoder and the training decoder to obtain the encoder and the decoder.

8. The method according to claim 7, further comprising:
sampling the training user data to obtain sampled data; and
performing distribution fitting on the sampled data to obtain a confidence interval.

9. The method according to claim 1, wherein the dimensions of a hidden layer in the encoder are greater than the dimensions of the first feature, and the dimensions of a hidden layer in the decoder are greater than the dimensions of the first feature.

10. The method according to claim 1, wherein the protection job property comprises at least one of asset size, transmitted bytes, cumulative size, pre-compression ratio, repeated pre-compression ratio, compressed size, number of segments, and redundant segment count of the user data, and the agent property comprises at least one of used bytes, changed bytes, moved bytes, final moved bytes, number of read seconds, number of write seconds, and total consumed time of the user data.

11. The method according to claim 1, further comprising:
sending, in response to the anomaly in the user data, report information to a user.

12. An electronic device, comprising:
at least one processor; and
a memory coupled to the at least one processor and having instructions stored therein, wherein the instructions, when executed by the at least one processor, cause the electronic device to perform actions comprising:
acquiring a first feature of user data, wherein the user data comprises at least one of a protection job property and an agent property;
generating a second feature by an auto-encoder based on the first feature, wherein the first feature and the second feature have the same dimensions, and the auto-encoder comprises an encoder and a decoder; and
detecting, based on the first feature and the second feature, a data anomaly in the user data.

13. The device according to claim 12, wherein generating the second feature by the auto-encoder based on the first feature comprises:
generating a third feature by the encoder based on the first feature, wherein the dimensions of the third feature are less than the dimensions of the first feature; and
generating the second feature by the decoder based on the third feature.

14. The device according to claim 13, wherein detecting, based on the first feature and the second feature, the data anomaly in the user data comprises:
determining a difference value between the first feature and the second feature; and
determining whether the difference value is in a confidence interval, wherein the confidence interval is determined based on the user data.

15. The device according to claim 14, wherein determining whether the difference value is in the confidence interval comprises:
determining, in response to the difference value being in the confidence interval, that the user data is normal; and
determining, in response to the difference value being outside the confidence interval, that the user data is abnormal.

16. The device according to claim 12, further comprising:
training the encoder and the decoder based on a training feature, wherein the training feature is determined based on training user data.

17. The device according to claim 16, wherein training the encoder and the decoder based on the training feature comprises:
acquiring the training user data in response to detecting an attack on a training user data system, wherein the training user data comprises at least one of a training protection job property and a training agent property; and
extracting the training feature based on the training user data.

18. The device according to claim 17, further comprising:
generating a second training feature by a training encoder and a training decoder based on a first training feature; and
adjusting, based on a loss between the first training feature and the second training feature, the training encoder and the training decoder to obtain the encoder and the decoder.

19. The device according to claim 18, further comprising:
sampling the training user data to obtain sampled data; and
performing distribution fitting on the sampled data to obtain a confidence interval.

20. A computer program product tangibly stored on a non-volatile computer-readable medium and comprising machine-executable instructions, wherein the machine-executable instructions, when executed by a machine, cause the machine to perform actions comprising:
acquiring a first feature of user data, wherein the user data comprises at least one of a protection job property and an agent property;
generating a second feature by an auto-encoder based on the first feature, wherein the first feature and the second feature have the same dimensions, and the auto-encoder comprises an encoder and a decoder; and
detecting, based on the first feature and the second feature, a data anomaly in the user data.
